(19) United States
(12) Patent Application Publication
(10) Pub. No.: US 2018/0276398 A1
(43) Pub. Date: Sep. 27, 2018

(54) SYSTEM AND METHOD FOR PROVIDING RESTRICTED ACCESS TO PRODUCTION FILES IN A CODE DEPLOYMENT ENVIRONMENT

(71) Applicant: O.C. Tanner Company, Salt Lake City, UT (US)

(72) Inventors: Trevor Forbes Linton, Salt Lake City, UT (US); Murray Lucas Resinski, Salt Lake City, UT (US); Michael Raymond Felix, Salt Lake City, UT (US); Cory Alexander Christopher, Salt Lake City, UT (US)

(21) Appl. No.: 15/465,495

(22) Filed: Mar. 21, 2017

(51) Int. Cl. G06F 21/62; G06F 21/60

(52) U.S. Cl. CPC G06F 21/6209; G06F 21/31; G06F 21/604

(57) ABSTRACT

A method for providing restricted access to a production file in a code deployment environment is presented. The method includes receiving a user request to access the production file comprising a plurality of configuration sections employed for one or more applications. Also, the method includes determining a user identity associated with the user request to access the production file. Further, the method includes identifying a permission level of the user identity based on at least one parameter of the user identity. In addition, the method includes providing restricted access to the production file based on the permission level of the user identity.

### BACKGROUND

Embodiments of the present specification relate generally to a code deployment environment, and more particularly to a system and method for providing restricted access to production files in the code deployment environment.

Typically, software applications are commonly developed under a collaborative effort by multiple code developers operating within a computing network. In general, the code developers (dev) build a source code in a code development environment. Further, the source code is provided to a production environment after testing and/or executing the source code by using one or more known methods or techniques. In the production environment, operation (Ops) personnel convert the source code into a production file that is used for one or more applications by end-users. In addition, the operation personnel may add sensitive information, such as passwords, keys, tokens etc. to the production file for authenticating or authorizing the end-users. Once the production file with the sensitive information is deployed or released in the production environment, the code developers (dev) are locked out of the production file or the real product.

However, if the released production file includes bugs or feature requests are made, the production file is sent back to the code developers for making necessary changes to the code. This in turn allows the code developers to view or access the sensitive information and/or unauthorized sections of the production file. Thus, it is desirable to restrict access to the production file prior to sending the production file to the code developers.

In a conventional system, operation (Ops) personnel may manually go through the production file and select the configuration sections for which the operation personnel desire masking. Further, when a user request is received, the selected configuration sections are masked in a copy of the production code. The problem with this approach is that the configuration sections need to be manually identified by the operation personnel in the production file, which is a hassle and time consuming process. Also, the configuration sections that are masked may be same for all the users irrespective of their role and permission, which is unacceptable in the code deployment environment. Thus, there is a need for an improved system and method for providing restricted access to the production file in the code deployment environment.

### BRIEF DESCRIPTION

In accordance with aspects of the present specification, a method for providing restricted access to a production file in a code deployment environment is presented. The method includes receiving a user request to access the production file comprising a plurality of configuration sections employed for one or more applications. Also, the method includes determining a user identity associated with the user request to access the production file. Further, the method includes identifying a permission level of the user identity based on at least one parameter of the user identity. In addition, the method includes providing restricted access to the production file based on the permission level of the user identity.

In accordance with another embodiment of the present specification, a production system for providing restricted access to a production file in a code deployment environment is presented. The production system includes a repository unit configured to store the production file comprising a plurality of configuration sections employed for one or more applications. Also, the production system includes a processor coupled to the repository unit and configured to receive a user request to access the production file comprising a plurality of configuration sections employed for one or more applications. Further, the processor is configured to determine a user identity associated with the user request to access the production file. In addition, the processor is configured to identify a permission level of the user identity based on at least one parameter of the user identity. Furthermore, the processor is configured to provide restricted access to the production file based on the permission level of the user identity.

In accordance with yet another embodiment of the present specification, a code deployment system for providing restricted access to a production file is presented. The code deployment system includes a production server configured to receive a user request to access the production file comprising a plurality of configuration sections employed for one or more applications. Further, the production server is configured to determine a user identity associated with the user request to access the production file. In addition, the production server is configured to identify a permission level of the user identity based on at least one parameter of the user identity. Furthermore, the production server is configured to provide restricted access to the production file based on the permission level of the user identity. Additionally, the code deployment system includes a developer server configured to obtain restricted access to the production file based on the permission level of the user identity.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical representation of a code deployment system for providing restricted access to a production file in a code deployment environment, in accordance with aspects of the present specification;

FIG. 2 is a diagrammatical representation of a production environment in the code deployment environment, in accordance with aspects of the present specification; and

FIG. 3 is a flow chart illustrating a method for providing restricted access to a production file in a code deployment environment, in accordance with aspects of the present specification.

### DETAILED DESCRIPTION

As will be described in detail hereinafter, various embodiments of systems and methods for providing restricted access to a production file in a code deployment environment is presented. In particular, the systems and methods presented herein restricts users from accessing or viewing one or more unauthorized sections/fields in the production file. Also, different users may have access to different sections/fields in the production file based on parameters, such as a role and a permission level of the users.

In the following specification and the claims, reference will be made to a number of terms, which shall be defined to have the following meanings. The singular forms “a”, “an”, and “the” include plural references unless the context clearly dictates otherwise.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the terms “software” and “firmware” are interchangeable, and include any computer program stored in memory for execution by devices that include, without limitation, mobile devices, clusters, personal computers, workstations, clients, and servers.

As used herein, the term “computer” and related terms, e.g., “computing device”, are not limited to integrated circuits referred to in the art as a computer, but broadly refers to at least one microcontroller, microcomputer, programmable logic controller (PLC), application specific integrated circuit, and other programmable circuits, and these terms are used interchangeably herein.

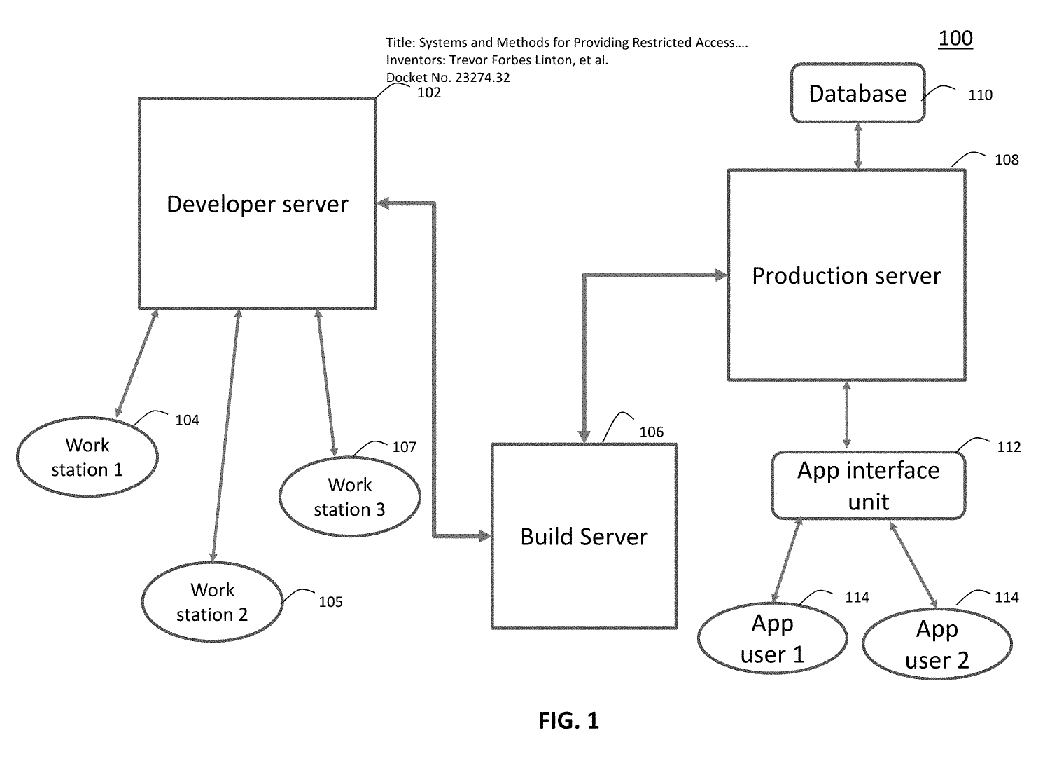

FIG. 1 is a diagrammatical representation of a code deployment system 100 in a code deployment environment for providing restricted access to a production file, in accordance with aspects of the present specification. The code deployment environment includes a development environment, a build environment, and a production environment. It may be noted that the code deployment environment may include other environments, and are not limited to the environments depicted in FIG. 1. Also, it may be noted that these environments may be referred by other similar terminologies.

In a presently contemplated configuration, the development environment is a working environment where software applications are commonly developed under a collaborative effort by multiple code developers operating within a computing network. More specifically, the development environment includes a developer server 102 that is communicatively coupled to a plurality of workstations 104, 105, 107. In one example, the developer server and the plurality of workstations 104, 105, 107 may be any computer device that can execute computer-readable instructions to perform one or more functions.

Further, the code developers may use these workstations 104, 105, 107 to build one or more code portions in their corresponding workstation. Thereafter, these code portions may be integrated and validated in the developer server 102 to form a source code. It may be noted that the source code may be built using one or more programming languages. In one example, the source code may include one or more configuration sections that are used for applications by end-users. Initially, when the source code is built, these configuration sections may include only non-sensitive variables/data. In one embodiment, the development environment may include code development tools, such as compliers, integrators, libraries, and support software for building and validating the source code. Also, the code developers may use these tools to make radical changes to the source code without adversely affecting other environments in the system 100.

Upon building the source code, the developer server 102 may communicate the source to a build environment to convert the source code to an executable code. Particularly, the build environment includes a build server 106 that is configured to perform different testing on the source code. In one embodiment, one or more quality assurance (QA) testers may review and execute the source code to detect bugs in the source code. Further, the QA testers may send QA reports to the code developers to fix the detected bugs in the source code. Also, the build environment may include a staging environment that is identical to the production environment. The staging environment may be used for other testing, such as performance testing, load testing, or the like. After fixing all the bugs in the source code, the source code is copied as an executable code in the build server 106. Further, the build server 106 may communicate this executable code to the production environment.

Furthermore, the production environment may be a network of many geographically distributed machines in data centers or virtual machines in cloud computing. In the embodiment of FIG. 1, the production environment includes a production server 108, a database 110, and an App interface unit 112 that is coupled to a plurality of App user devices, such as a first App user device 114 and a second App user device 114. In one example, the App user devices 114 may include laptops, mobile phones, distributed machines, virtual machines, or the like. Similarly, the App interface unit 112 may be a device or the cloud computing network. In one example, the production environment may include other components/devices, and are not limited to the devices mentioned in FIG. 1. Also, these devices/components may be any computer device that can execute computer-readable instructions to perform one or more functions.

The production server 108 may be configured to convert the executable code to a production file that may be used for one or more applications by the end-users using the App user devices 114. More specifically, operation personnel (Ops) may identify different configuration sections in the executable code where sensitive variables may be added into the executable code. In one example, the sensitive variables may include sensitive information, such as passwords, keys, tokens, or the like. These sensitive variables may be used to authorize the end-users prior to providing application service to the end-users. Also, the operational personnel may tag these configuration sections with a predefined tag. For example, the configuration sections having the sensitive variables are associated with a SOC tag/flag. Moreover, the executable code with the sensitive variables and the non-sensitive variables are copied into the database as a production file. Further, the production file may be deployed or released in the production environment for the end-users to use the applications corresponding to the production file.

Once the production file with the sensitive variables/information is deployed or released in the production environment, the code developers (dev) are locked out of the production file or a real product. However, if the released production file includes new bugs and/or feature requests are made, the production file may be sent back to the development environment to make necessary changes. As the production file is sent to the development environment, any unauthorized users, such as the code developers may access or view the sensitive variables/information in the production file.

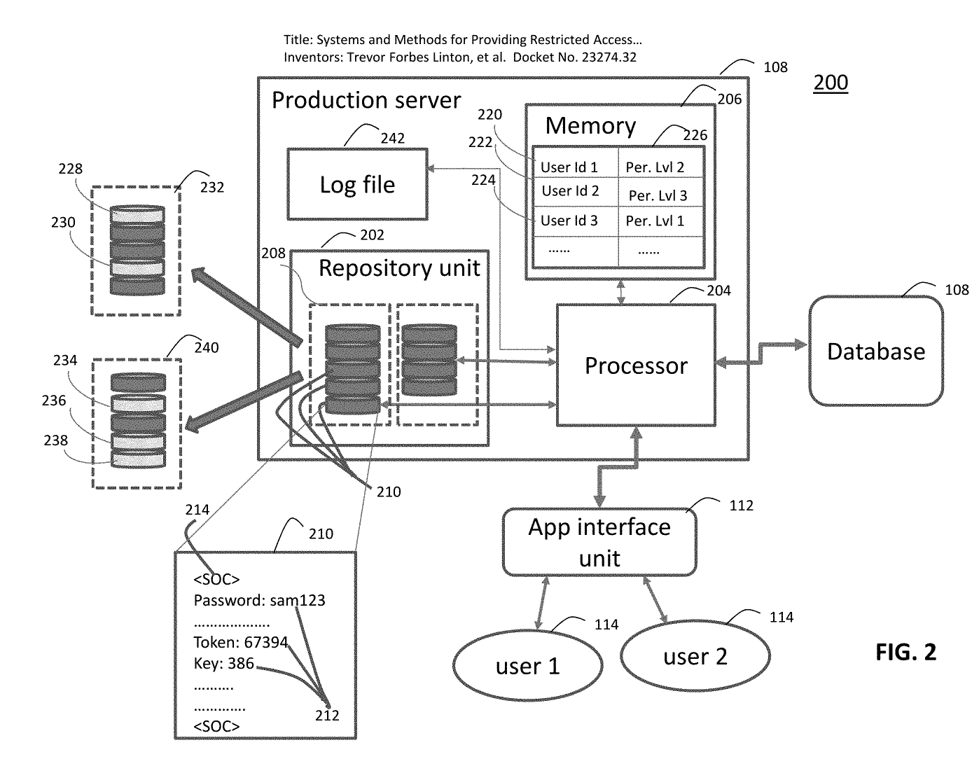

To overcome the above problems/shortcomings, the exemplary production server 108 is configured to restrict access to the production file based on roles and permissions of the user, such as the code developer of the production file. In particular, the production server may determine a permission level for each of the code developers in the development environment. Based on the determined permission level, the production server may redact or mask one or more configuration sections of the production file. In one example, these configuration sections may include sensitive variables/information that are restricted from viewing and/or accessing by the corresponding code developer. Further, the production server may send or provide access to the code developers to view or make necessary changes to the production file. In one embodiment, a web link is provided to the code developers for providing access to the redacted version of the production file. In one example, one-time access may be provided to these code developers. The aspect of restricting access to the production file in the code deployment environment is explained in greater detail with reference to FIG. 2.

At the development environment, the code developers make necessary changes to the non-sensitive variables in the production file to fix the new bugs and/or add new features to the production file. As certain sections in the production file are redacted, the code developers may not view or access these sections in the production file. Further, the production file may be sent to the build environment to undergo one or more testing, and thereafter the production file is again deployed or released in the production environment. In one embodiment, a new version of the production file may be released or a portion of the production file where the changes are made may be released in the production environment. It may be noted that the production file may be released in one more methods, and is not limited to the method mentioned herein.

Thus, by employing the exemplary code deployment system, particularly, the production server 108, the production file may be secured from the unauthorized users. Also, the changes in the production file are made by the users without accessing the sensitive variables in the production file. Moreover, the changes are made only to the redacted version of the production file, and thus the sensitive information is not permanently lost in the production environment.

Referring to FIG. 2, a diagrammatical representation of a production environment 200 having a production server 108 for providing restricted access to a production file 208, in accordance with aspects of the present specification is depicted. The production server 108 includes a repository unit 202, a processor 204, and a memory 206. Also, the production server 108 is communicatively coupled to one or more App user devices 114 via the App interfacing unit 112. The App user devices 114 may use the production file 208 in the production server for one or more applications. Also, the database 108 may be used to store a copy of the production file 108 that may be used for other applications in the later stage. It may be noted that the terms “production server” and “production system” may be used interchangeably in the below specification.

In the exemplary embodiment, the processor 204 may be configured to store the executable code received from the build server 106 in the repository unit 202. Also, the processor 204 may convert the executable code to a production file 208 having one or more configuration sections 210. These configuration sections 210 are used by end-users for one or more applications. Also, the processor 204 may add sensitive variables 212 along with the existing non-sensitive variables in the configuration sections 210 of the production file. The sensitive variables 212 may include sensitive information such as, passwords, keys, tokens, URI spec. having password, or the like. It may be noted that the sensitive variables 212 may include other types of information, and is not limited to the information mentioned herein. Further, the processor 204 may associate the configuration sections 210 having the sensitive variables 212 with a predefined tag 214. In one example, the configuration sections 210 having the sensitive variables 212 are associated with a SOC tag 214.

During operation, the processor 204 may receive a list of users who are working on the production file 208. In one example, the users may include code developers, quality testers, a release manager, or operation personnel. For each of the users, the processor 204 may assign a corresponding user identity. For ease of understanding of the invention, the workstations 104, 105, 107 in the development environment are considered as the user devices and their identity as the user identity in the below description. However, it may be noted that multiple users (code developers) may use the same workstation with a different user identity or login data.

As depicted in FIG. 2, the processor 204 may create a list of user identities in the memory 206. For example, a first workstation 104 is associated with a first user identity 220. Similarly, a second workstation 105 is associated with a second user identity 222 and a third workstation 107 is associated with a third user identity 224. Also, the processor 204 may create a table 226 by mapping each of the user identities 220, 222, 224 with a corresponding permission level. In one example, the first user identity 220 of the first work station 104 may be mapped with a permission level 2. Similarly, the second user identity 222 of the second work station 105 may be mapped with a permission level 3, and the third user identity 107 of the third work station 224 may be mapped with a permission level 1. In one example, the permission level may indicate whether the user is a high privileged user or a low privileged user. The high privileged user may access or view most of the sections/data in the production file 208, while the low privileged user may access or view limited sections/data in the production file 208. Also, for high privileged user, the permission level 1 is assigned and for a low privileged user, the permission level 3 is assigned.

In one embodiment, the processor 204 may determine the permission level based on one or more parameters of the corresponding user identity. The parameters may include a role, a location, and/or data accessed time of the user associated with the user identity. In one embodiment, if the user is at a higher role, the permission level 1 is assigned to his/her user identity. In another embodiment, if the user is at a predetermined location and/or requesting to access data from the production file at a predefined time interval, the permission level 2 is assigned to his/her user identity. It may be noted that one or more parameters, or different combination of parameters may be used for assigning the permission level to the users. In one embodiment, the processor 204 may monitor a change in the one or more parameters of the user identity. Further, the processor 204 may modify the associated permission level based on the change in the parameters of the user identity. For example, if the user is promoted to a higher role, the permission level may be changed from the permission level 2 or 3 to the permission level 1.

Further, when a user request is received from the user to access the production file 208, the processor 204 may determine the user identity associated with the received user request. In one example, the user request may include login data of the user. The processor 204 may extract this login data to determine the user identity of the user. In another example, the user request may include IP address of the user's workstation, and the processor may determine the user identity based on this IP address. After determining the user identity, the processor 204 may identify a permission level mapped to this user identity in the table 226 stored in the memory 206.

Furthermore, the processor 204 may redact one or more configuration sections 210 in the production file 208 based on the identified permission level. For example, if the user identity is associated with a permission level 2, the processor 204 may redact a first and fourth configuration sections 228, 230 as depicted in the production file 232 of FIG. 2. In another example, if the user identity is associated with a permission level 3, the processor 204 may redact second, fourth, and fifth configuration sections 234, 236, 238 as depicted in the production file 240 of FIG. 2. In one embodiment, the processor 204 may redact the configurations section by replacing the sensitive variables/data in the configuration section with a predefined characters, numbers, words, strings, or the like. In another embodiment, the processor 204 may redact the configurations section by replacing all the data including the sensitive and non-sensitive variables in the configuration section with the predefined characters, numbers, words, strings, or the like. It may be noted that the user identities may be associated with any permission level, and are not limited to the permission level shown in FIG. 2.

In one embodiment, when the user request is received, the processor 204 may execute one or more instructions stored in the memory 206 to run a program for redacting the configuration sections in the production file 208. It may be noted that, these instructions may be stored in one or more programming languages in the memory 206. Also, the program may be executed based on one or more policies that are predetermined for redacting the production file 208 and/or other data in the production environment. In one embodiment, these policies may be stored along with the production file 208 in the repository unit 202. Also, these policies may be customized based on one or more data security requirements in the production environment. In one example, the processor 204 may automatically execute the instructions stored in the memory 206 in real-time to restrict access to the production file 208.

After redacting the configuration sections in the production file 208, the processor 204 may provide access to the production file 208 to the corresponding user, e.g., the code developer. In one embodiment, the processor 204 may send a web link to the developer server 102 for providing access to the redacted production file in the production server 108. In another embodiment, the processor 204 may provide one-time access to the redacted production file to the users.

After gaining restricted access to the production file, the users or the code developers make necessary changes to the non-sensitive variables in the production file to fix the new bugs and/or add new features to the production file. Further, the production file may be sent to the build environment to undergo one or more testing, and thereafter the production file is again deployed or released in the production environment.

In one embodiment, the processor 204 may maintain a log file 242 to track information including accessed data of the production file, frequency of data usage, and time of data accessed by the users. This log keeps a track of the users, such as the code developers who are accessing the data of the production file. At a later stage, this log file 242 may be used for tracking different users accessing data and their changes done to the production file.

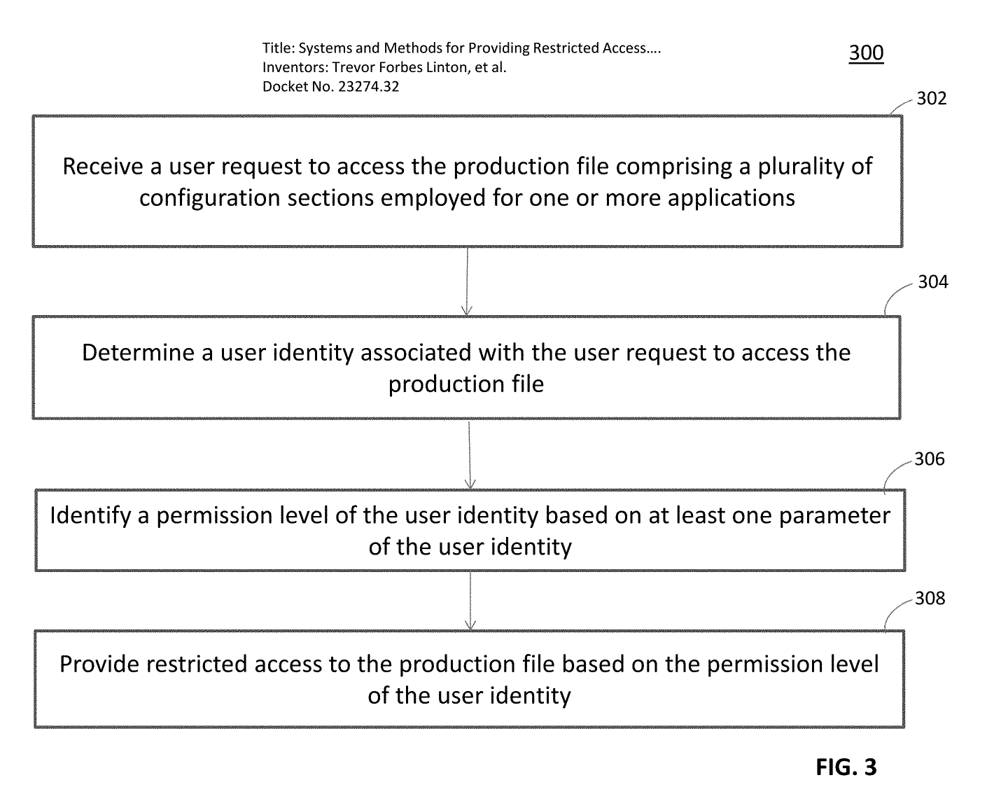

FIG. 3 is a flow chart illustrating a method 300 for providing restricted access to a production file in a code deployment environment, in accordance with aspects of the present specification. For ease of understanding, the method 300 is described with reference to the components of FIGS. 1 and 2. The method 300 begins with a step 302, where a processor 204 in the production server 108 receives a user request to access the production file 208 including a plurality of configuration sections that are employed for one or more applications. In one example, a user may include login data or IP address in the user request that is provided to the processor 204.

Subsequently, at step 304, the processor 204 determines a user identity associated with the user request to access the production file 208. In particular, the processor 204 may extract login data included in the user request. Further, the processor 204 may determine the user identity based on the extracted login data.

In addition, at step 306, the processor 204 identifies a permission level of the user identity based on at least one parameter of the user identity. In one embodiment, the processor 204 may initially create a table 226 by mapping each of the user identities with a corresponding permission level. Further, when the user request is received, the processor 204 may identify the permission level that is associated with the user identity in the table. In one embodiment, the processor 204 may determine the permission level based on one or more parameters of the corresponding user identity. The parameters may include a role, a location, and/or data accessed time of the user associated with the user identity.

Furthermore, at step 308, the processor 204 provides restricted access to the production file based on the permission level of the user identity. More specifically, the processor 204 may redact one or more configuration sections in the production file 208 based on the identified permission level. For example, if the user identity is associated with a permission level 2, the processor 204 may redact a first and fourth configuration sections 228, 230 as depicted in the production file 232. In one example, the processor 204 may redact full data or partial data in these configuration sections. It may be noted that the user identities may be associated with any permission level, and are not limited to the permission level depicted in FIG. 2.

The various embodiments of the exemplary systems and methods presented hereinabove aid in providing restricted access to the production file in a code deployment environment. In particular, the systems and methods presented herein restricts users from accessing or viewing one or more sections of the production file. Moreover, the production file is redacted in a real-time without persistently altering the actual data in the production file.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

While the technology has been described in detail in connection with only a limited number of implementations, it should be readily understood that the invention is not limited to such disclosed implementations. Rather, the technology can be modified to incorporate any number of variations, alterations, substitutions or equivalent arrangements not heretofore described, but which are commensurate with the spirit and scope of the disclosure. Additionally, while various implementations of the technology have been described, it is to be understood that aspects of the technology may include only some of the described implementations. Accordingly, the inventions are not to be seen as limited by the foregoing description, but are only limited by the scope of the appended claims.

1. A method for providing restricted access to a production file in a code deployment environment, the method comprising:
receiving a user request to access the production file comprising a plurality of configuration sections employed for one or more applications;
determining a user identity associated with the user request to access the production file;
identifying a permission level of the user identity based on at least one parameter of the user identity; and
providing restricted access to the production file based on the permission level of the user identity.

2. The method of claim 1, further comprising maintaining a log file to track information including accessed data of the production file, frequency of data usage, and time of data accessed.

3. The method of claim 2, wherein the log file is maintained for a plurality of users including a user associated with the user identity.

4. The method of claim 3, wherein the at least one parameter of the user identity comprises a role, a location, and data accessed time of the user associated with the user identity.

5. The method of claim 4, wherein the user comprises a code developer, a quality person, a release manager, or an operation person.

6. The method of claim 1, wherein identifying the permission level of the user identity comprises:
comparing the user identity with a plurality of user identities, wherein each of the user identities is associated with a corresponding permission level; and
determining the permission level based on the user identity matching with one of the user identities.

7. The method of claim 6, further comprising:
monitoring a change in the at least one parameter of the user identity; and
modifying the permission level based on the change in the at least one parameter of the user identity.

8. The method of claim 1, wherein providing restricted access to the production file comprises:
determining one or more predetermined sections of the production file that are associated with the permission level of the user identity;
restricting access to the one or more predetermined sections of the production file in response to the received user request.

9. The method of claim 1, wherein determining the user identity associated with the user request comprises:
extracting login data included in the user request; and
determining the user identity based on the extracted login data.

10. A production system for providing restricted access to a production file in a code deployment environment, the production system comprising:
a repository unit configured to store the production file comprising a plurality of configuration sections employed for one or more applications;
a processor coupled to the repository unit and configured to:
receive a user request to access the production file comprising a plurality of configuration sections employed for one or more applications;
determine a user identity associated with the user request to access the production file;
identify a permission level of the user identity based on at least one parameter of the user identity; and
provide restricted access to the production file based on the permission level of the user identity.

11. The production system of claim 10, wherein the processor is configured to maintain a log file to track information including accessed data of the production file, frequency of data usage, and time of the data accessed.

12. The production system of claim 11, wherein the processor is configured to maintain the log file for a plurality of users including a user associated with the user identity.

13. The production system of claim 12, wherein the at least one parameter of the user identity comprises a role, a location, and data accessed time of the user associated with the user identity.

14. The production system of claim 13, wherein the user comprises a code developer, a quality person, a release manager, or an operation person.

15. The production system of claim 10, wherein the processor is configured to:
compare the user identity with a plurality of user identities, wherein each of the user identities is associated with a corresponding permission level; and
determine the permission level based on the user identity matching with one of the user identities.

16. The production system of claim 15, wherein the processor is configured to:
monitor a change in the at least one parameter of the user identity; and
modify the permission level based on the change in the at least one parameter of the user identity.

17. The production system of claim 10, wherein the processor is configured to:
determine one or more predetermined sections of the production file that are associated with the permission level of the user identity; and
restrict access to the one or more predetermined sections of the production file in response to the received user request.

18. The production system of claim 10, wherein the processor is configured to:
extract login data included in the user request; and
determine the user identity based on the extracted login data.

19. A code deployment system for providing secure access to a production file, the code deployment system comprising:
a production server configured to:
receive a user request to access the production file comprising a plurality of configuration sections employed for one or more applications;
determine a user identity associated with the user request to access the production file;
identify a permission level of the user identity based on at least one parameter of the user identity; and
provide restricted access to the production file based on the permission level of the user identity.
a developer server configured to obtain restricted access to the production file based on the permission level of the user identity.

20. The code deployment system of claim 19, wherein the production server is configured to provide a one-time restricted access to the production file.
